(19) United States
(12) Patent Application Publication
(10) Pub. No.: US 2026/0221895 A1
(43) Pub. Date: Jul. 30, 2026

(54) Power Conversion Systems and Methods with Power Air Core Inductors

(71) Applicant: The Trustees of Columbia University in the City of New York, New York, NY (US)

(72) Inventors: Matthias PREINDL, New York, NY (US); Youssef Amr Fahmy, New York, NY (US)

(73) Assignee: The Trustees of Columbia University in the City of New York, New York, NY (US)

(21) Appl. No.: 19/457,491

(22) Filed: Jan. 23, 2026

Related U.S. Application Data
(60) Provisional application No. 63/749,167, filed on Jan. 24, 2025.

(51) Int. Cl. H02M 7/23

(52) U.S. Cl. CPC H02M 7/23

(57) ABSTRACT

Disclosed are implementations that include an energy storage element for power conversion systems, including an inductor structure including multiple interwoven air core inductors, with each air core inductor including at least one set of wire winding defining an interior core that is free of any other structure. The energy storage element further includes multiple coupling terminal sets electrically coupled to the at least one set of wire winding of respective ones of the multiple interwoven air core inductors of the inductor structure, with the multiple coupling terminal sets configured to electrically couple the inductor structure to circuitry of a power conversion system. In some embodiments, the multiple interwoven air core inductors comprising the inductor structure may be orthogonal to each other. In some embodiments, the inductor structure may include three interwoven air core inductors, with the inductor structure being electrically couplable to circuitry of a 3-phase power conversion system.

### CROSS-REFERENCE TO RELATED APPLICATIONS

This application claims the benefit of, and priority to, U.S. Provisional Application No. 63/749,167, filed Jan. 24, 2025, entitled “Power Air-Core Inductors for High-Frequency, High-Ripple, Soft-Switching Inverters,” the content of which is incorporated herein by reference in its entirety.

### BACKGROUND

Small, efficient power electronics are a key part of the electrification of global energy use. These electronics typically require magnetics, be they inductors, transformers, or both, to provide everything from galvanic isolation, to filtering, to resonance. However, these magnetics can be difficult to design optimally and often require complex simulations to select interacting parameters such as core size, core material, airgap, and winding structure. Losses in particular can be calculated but are not always accurate, especially when the exciting waveforms are non-sinusoidal, high frequency, or high magnitude.

### SUMMARY

Disclosed are implementations that use air core inductors for operation in power converters, including variable frequency soft-switching converters. The air core inductors can be arranged into interwoven structures, e.g., interwoven structures with three air core inductors that are referred to as “triaxial inductors.” Triaxial inductors have three distinct yet interwoven windings that are wound such that they are all mutually orthogonal, effectively decoupling them. This creates, in some embodiments, a shape reminiscent of the monkey fist knot. The interwoven inductors are designed, constructed, characterized, simulated, and compared experimentally to individual air core inductors of similar inductance. Thermal equilibrium experiments at 10 kW and efficiency comparisons up to 20 kW were performed to test the proposed implementations with a peak inverter efficiency of 98.7% being achieved. The triaxial inductors are shown to have similar losses to the individual inductors, with power densities increasing by up to 3.3×, all while remaining totally uncoupled. Electromagnetic interference from the inductors is shown to not affect inverter operation or control.

Thus, in some variations, a voltage inverter system is provided that includes multiple phase circuits with multiple air core inductors, to invert DC voltage provided by a DC voltage source connected to the multiple phase circuits, into a multiple phase AC output voltage. Each of the multiple phase circuits includes at least one air core inductor from the multiple air core inductors, the at least one air core inductor including at least one set of wire winding defining a core, with the core being free of any other structure. Each of the multiple phase circuits also includes one or more switching devices to control electrical current passing through the at least one air core inductor. The system further includes one or more controllers to controllably actuate the one or more switching devices of the each of the multiple phase circuits to maintain soft-switching behavior of the voltage inverter system based, in part, on characteristics of the multiple air core inductors.

Embodiments of the system may include at least some of the features described in the present disclosure, including one or more of the following features.

The multiple air core inductors, included in the multiple phase circuits, may be arranged into a single interwoven inductor structure.

The single interwoven inductor structure can define an inductor structure volume that is smaller than the sum of volumes occupied individually by the multiple air core inductors when separated from each other.

The multiple air core inductors including the single interwoven inductor structure may be orthogonal to each other.

The single interwoven inductor structure can include one of, for example, an interwoven ovel triaxial inductor structure with separate windings of each of the multiple inductors arranged on oval interwoven bobbins, or a ball-shaped triaxial inductor structure with the separate windings of each of the multiple inductors arranged on circular bobbins or a ball-shaped bobbin.

The multiple phase circuits can include three phase circuits.

The one or more controllers may be configured to determine variable switching frequencies for each of the one or more switching devices of the multiple phase circuits.

Each of the multiple phase circuits can further include a capacitor electrically coupled at a first of its terminals to a first terminal of a respective air core inductor, and electrically coupled at a second of its terminals to a negative terminal of the DC voltage source. A second terminal of the respective air core inductor is electrically coupled to common terminals of the one or more respective switching devices.

The multiple phase circuits, with the multiple air core inductors, may be configured to operate at high current levels and/or at high current frequencies.

In some variations, a voltage inversion method is disclosed that includes measuring electrical properties of a voltage inversion system that includes multiple phase circuits, with multiple air core inductors, to invert DC voltage provided by a DC voltage source connected to each of the multiple phase circuits, into a multiple phase AC output voltage. Each of the multiple phase circuits includes at least one air core inductor from the multiple air core inductors, with the at least one air core inductor including at least one set of wire winding defining a core, and with the core being free of any other structure. Each of the multiple phase circuits also includes one or more switching devices to control electrical current passing through the at least one air core inductor. The method additionally includes controlling, based, at least in part, on the measured electrical properties of the voltage inversion system and on characteristics of the multiple air core inductors, electrical operation of the multiple phase circuits to maintain soft-switching of the voltage inversion system.

Embodiments of the method may include at least some of the features described in the present disclosure, including at least some of the features described above in relation to the system, as well as one or more of the following features.

Controlling the electrical operation of the multiple phase circuits can include controllably actuating the one or more switching devices respectively included in the each of the multiple phase circuits to maintain soft-switching operation of the voltage inversion system.

The multiple air core inductors, respectively included in the multiple phase circuits, may be arranged into a single interwoven inductor structure.

In some variations, an energy storage element for power conversion systems is provided. The energy storage element includes an inductor structure comprising multiple interwoven air core inductors, each air core inductor including at least one set of wire winding defining an interior core that is free of any other structure, and multiple coupling terminal sets electrically coupled to the at least one set of wire winding of respective ones of the multiple interwoven air core inductors of the inductor structure, the multiple coupling terminal sets configured to electrically couple the inductor structure to circuitry of a power conversion system.

Embodiments of the energy storage element may include at least some of the features described in the present disclosure, including at least some of the features described above in relation to the system and the method, as well as one or more of the following features.

The inductor structure may include three interwoven air core inductors, with the inductor structure being electrically couplable to circuitry of a 3-phase power conversion system.

The inductor structure comprising the three interwoven air core inductors may be configured to output at least 2.5 kW of power.

The multiple coupling terminal sets configured to electrically couple the inductor structure to the circuitry of the power conversion system can include multiple coupling terminal pairings that each electrically couple to a respective one of multiple phase circuits of the power conversion system.

Other features and advantages of the invention are apparent from the following description, and from the claims.

### BRIEF DESCRIPTION OF THE DRAWINGS

These and other aspects will now be described in detail with reference to the following drawings.

FIG. 1 is a circuit diagram of an example power inversion platform using air core inductors.

FIG. 2 is a cross sections diagram of an example air-core inductor.

FIG. 3 is a graph illustrating the behavior of the optimized Wheeler formulation for an air core inductor with a fixed shape ratio of 0.45.

FIG. 4 includes an image of various inductors used in the testing and evaluation of an example system similar to the system of FIG. 1.

FIG. 5 includes diagrams of bobbin structures used for constructing various air-core inductor configurations.

FIG. 6A includes plots showing self-inductances and frequency dependent resistances of various inductors that were tested and evaluated.

FIG. 6B is a plot of an average quality factor (Q factor) values for different types of 3-winding inductors.

FIG. 7 includes images representing simulation results showing the distribution of magnetic flux density for a simulated cored inductor and for a simulated individual air core inductor.

FIG. 8 includes images representing simulation results showing how a magnetic field of a ball inductor varies at different sinusoidal excitations.

FIG. 9 includes an image of an example software-defined power electronics (SDPE) testing platform.

FIG. 10 includes plots of voltage measurements for the converter of FIG. 9 when using a cored inductor.

FIG. 11 includes plots of voltage measurements for the converter of FIG. 9 when using an oval inductor.

FIG. 12 includes plots showing a step response of the converter of FIG. 9 to a 20 Aₚₖ change in grid current reference.

FIG. 13 includes plots showing circuit operation using a ball inductor.

FIG. 14 includes infrared photographs of various inductor types when operating at a thermal equilibrium and P_{AC}=10 kW.

FIG. 15 includes plots showing results of measured peak emitted H-field.

FIG. 16 includes a plot showing efficiency measurements of different inductors for up to 20 kW of power.

FIG. 17 includes a plot of waveform results for the converter of FIG. 9 when using an air core inductor.

FIG. 18 includes a plot of an efficiency comparison between an air core and a cored inductor setups.

FIG. 19 is a flowchart of an example voltage inversion procedure.

### DESCRIPTION

The proposed power implementations described herein include grid-tied multi-phase, soft-switching, inverter circuits (coupled to such outputs as a grid, a charging interface, etc.) that use air core inductors, i.e., inductors with windings defining interior cores that are free of any other structure (e.g., free of an iron or ferrite structure in the core). The combination of switching frequencies in the hundreds of kilo Hertz and peak currents over 100 A, necessary for soft-switching over the entire grid cycle, causes significant iron loss in cored inductor designs. The novel use of air core inductors in power applications as described herein, with power levels of, in some embodiments, 8 kW per inductor, eliminates these losses, improving overall converter efficiency. A comparison in design and performance with a ferrite-cored inductor is made and the air core is shown to be ≥0.5% more efficient at rated power, with higher savings at partial power. The design reduces weight while increasing volume to maintain inductance. Radiated electromagnetic interference is shown to be benign to the circuit's operation in practice.

Soft-switching grid-tied inverter circuits that use on air core inductors have several advantages. First, the lack of magnetic material means that there is little chance of nonlinear inductance behavior through saturation. For the same reason, there are no core losses. Both the hysteresis loss, caused by nonlinear realignment of magnetic domains, and eddy current loss, caused by induced electric fields in the core itself, are no longer possible. These losses, commonly modeled by variations on the Steinmetz equation are the most complicated to model. The inductor design process is significantly simplified by discounting these equations, which are empirical and accurate over a limited range of operating conditions.

Thus, the proposed power implementations include, in some embodiments, a voltage inverter system that includes multiple phase circuits (e.g., three phases, in some examples), with multiple air core inductors, to invert DC voltage provided by a DC voltage source connected to each of the multiple phase circuits, into a multiple phase AC output voltage. Each of the multiple phase circuits includes at least one air core inductor from the multiple air core inductors, with the at least one air core inductor including at least one set of wire winding defining a core, with the core being free of any other structure (such as a magnetic element), and one or more switching devices to control electrical current passing through the at least one air core inductor. The inverter implementations also includes one or more controllers to controllably actuate the one or more switching devices of the each of the multiple phase circuits to maintain soft-switching behavior of the voltage inverter system based, in part, on characteristics of the multiple air core inductors. It is noted that, in some embodiments, the air core inductors can also be used in other types of power applications (or in other types of non-power applications), such as AC/DC power conversion, etc.

As will be discussed in greater detail below, the technology described herein uses, in some embodiments, proposed novel interwoven air core inductor structures. One challenge of using conventional air core inductors (e.g., in power system implementations, such as 3-phase grid-tied inverters), is the increase in volume for such conventional air core inductors that is required to achieve the same inductance that would be achieved by a regular inductor. The proposed triaxial air core inductors mitigate this challenge by creating (e.g., for a multi-inductor structure) an interwoven multi-inductor structure in which multiple air core inductors are passed through one another (e.g., to form a ball-like inductor structure). This allows the multiple inductors (e.g., three inductors for 3-phase power implementations) to reuse the same volume, increasing power density. Thus, as will be described below, the proposed implementations include a new family of power inductors that incorporates multiple similar inductors interwoven into a single construct to facilitate the generation of magnetic fields for the purpose of processing power. When the interwoven inductor structure includes three similar air core inductors, the resultant inductor structure is referred to as triaxial inductor.

Conventional multiphase magnetics, primarily in the form of 3-phase transformers and coupled inductors, depend on the coupling of multiple magnetic fields together, through the use of magnetic cores or the positioning of the coils. The interwoven multi-air core inductor configurations (such as the triaxial-inductor configurations) described herein, avoid coupling by placing the inductors orthogonal to one another. The independence of the three inductors will be demonstrated through coupling measurements and experimentation discussed below.

Thus, the power implementations (and/or other non-power implementations) described herein include an energy storage element for power conversion systems that includes an inductor structure comprising multiple interwoven air core inductors, with each air core inductor including at least one set of wire winding defining an interior core that is free of any structure, and multiple coupling terminal sets electrically coupled to the at least one set of wire winding of respective ones of the multiple interwoven power air core inductors of the inductor structure. The multiple coupling terminal sets configured to electrically couple the inductor structure to circuitry of a power conversion system. In some embodiments, the inductor structure defines an inductor structure volume that is smaller than the sum of volumes occupied by the multiple air core inductors when separated from each other.

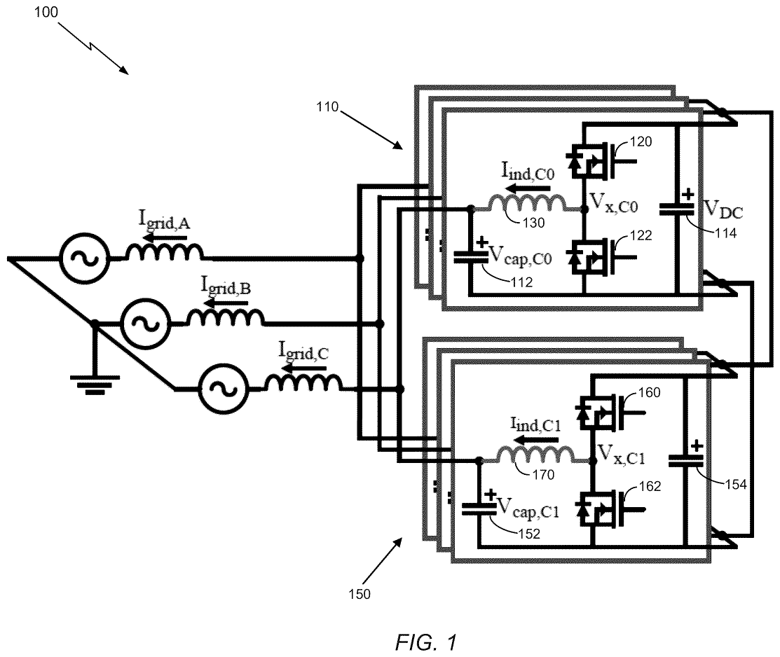

Details of power conversion systems that use air core inductors are next discussed with reference to FIG. 1, which includes a circuit diagram of an example variable frequency soft-switching (VFSS) power inversion platform 100. However, other types of power conversion platforms may also be implemented using the air core inductors described herein. The example power inversion platform 100 may be implements for an EV (electric vehicle) charger stage that uses variable frequency critical soft-switching, with air core inductors.

In some embodiments, the platform is configured as a 3-phase grid connected inverter that uses duty cycle control with a VFSS scheme. The platform can be optionally interleaved to increase the power output. As depicted in FIG. 1, for the particular power inversion platform 100, two inverters 110 and 150 (each including circuitry for three phases) are placed in parallel to allow higher power operation by utilizing global synchronization and interleaving of the modules. Paralleling on the output side, as is carried out in the inverter created to demonstrate these effects, is optional and does not affect circuit operation.

For the illustrated circuitry for phase C of the inversion platform 100 (i.e., the circuitry producing the current I_{grid, C0} and I_{grid, C0}), the inverters 110 and 150 of the phase C circuitry include a connection between the star point of the filter capacitors (112 and 152 in FIG. 1) and the DC negative terminals 114 and 154 in FIG. 1. This introduces a path for zero sequence current (ZSC) to flow, but it also allows for simple, symmetric control in the DQZ domain using the Park-Clarke transformations. The platform is fundamentally bidirectional and produces a rectified DC voltage from which it can provide positive or negative real and reactive powers using PI controllers.

As switching frequencies rise, both the dead times and the inductances tend to decrease. The first is in an effort to mitigate distortion, which occurs when the dead-time becomes comparable to the switching period. The second occurs in an effort to increase power density. Additionally, in order to meet higher power demands, both operating voltages and currents are trending upwards. The increased current demand drives up the size of individual control switching devices (e.g., MOSFETs) 120, 122, 160, and 162, which tend to increase the drain-source capacitance. Synchronization and interleaving of MOSFET switching has been used to improve efficiency and reduce circulating currents. Synchronization removes any uncertainty that may be introduced by the microcontroller when updating duty cycle and switching frequency values, improving stability. Interleaving works by taking advantage of destructive interference in the ripple currents present in the LC filter of the two parallel conversion circuitries. These ripples, which flow into the filter capacitor, can be partially canceled if the two converters, operating with the same duty cycle and switching frequency, operate with a phase shift of 180°. The partial cancellation reduces current stress on the filter capacitors and improves filter response by effectively doubling the apparent frequency. Interleaving is common in implementations that utilize synchronization. In some embodiments, the platform can optionally implement zero voltage switching (ZVS), thus eliminating MOSFET turn-on losses by manipulating circuit conditions such that there is no voltage between the drain and source at turn-on.

As further shown in FIG. 1, each phase circuitry includes an air core inductor, such as the inductors 130 and 170 through which current (marked, for the phase C circuitry, as I_{ind,C0} and I_{ind,C1}), flows. One terminal of each of the air core inductors 130 and 170 is coupled to the common terminals of the respective MOSFET devices, and the other inductor terminal is coupled to one of the respective capacitor's terminals.

Design and operation of the air core inductors is based on the following factors. The first parameter to choose for the inductor is the required inductance itself. For a three-phase inverter circuit, three identical inductors can be used in the power factor correction (PFC) stage of an EV charger. The circuit topology shown in FIG. 1 differs from a traditional inverter by the connection of the DC negative terminal to the capacitors' star points. As noted, this decouples the switching instances of the phases and allows for single phase analysis to describe the system.

The relationship between inductor current ripple ΔI and switching frequency f_{sw} is given by

$${f}_{SW} = \frac{D ( 1 - D ) {V}_{DC}}{Δ IL} , \qquad ( Eq . 1 )$$

where D is the duty cycle, V_{DC} is the DC bus voltage, and L is the filter inductance to be determined. It is this relationship that can be controlled to ensure soft-switching. The inductance value is chosen such that soft-switching will be maintained in all operating conditions under variable switching frequency operation. It is assumed that the DC bus value is a constant and set, such that the duty cycle range, which depends on the ratio of the bus to the grid voltage magnitude, is roughly between [0.1, 0.9]. This will prevent the main control parameter, D, from saturating.

The ripple needed to soft-switch is determined by:

$$Δ I = α ( {I}_{grid} + {I}_{LIM} ) , \qquad ( Eq . 2 )$$

where α is a parameter set at 2, I_{grid} is the sinusoidal grid current, and I_{Lim} is a parameter set such that there is enough excess ripple to soft-switch the MOSFETs switching devices. The value of I_{grid} is determined by the specifications of the converter under consideration. For example, if using a European 400V grid at 50 Hz, to achieve 25 kW, the grid current needs to be approximately 51 Aₚₖ.

To determine the necessary inductance, Eq. 1, above, can be solved for L and, using the above values, the maximum ripple, which for real power occurs at the peaks of grid voltage, can be compared to the inductance. The lower bound on the minimum switching frequency is set by the top of the audible range. Meanwhile, switching frequencies are limited from above by duty cycle distortions that arise when rise, fall, and dead times become a significant portion of the pulse time, around 600 kHz. A value of 8-10 μH operating with a target bus of 800V provides a good margin for operation in the 40-50 kHz range at maximum current in a 25 kW converter. Inductance values that are smaller than calculated using this procedure will simply provide excess current ripple. Although this is not necessarily optimal for overall efficiency, it will ensure soft-switching operation throughout the grid cycle. Having a target range instead of a specific value will allow for inductance variation.

The inductance of an air core inductor is described by the empirical Wheeler formula. It is traditionally given by

$$L = \frac{{a}^{2} {n}^{2}}{9 a + 10 b} \qquad ( Eq . 3 )$$

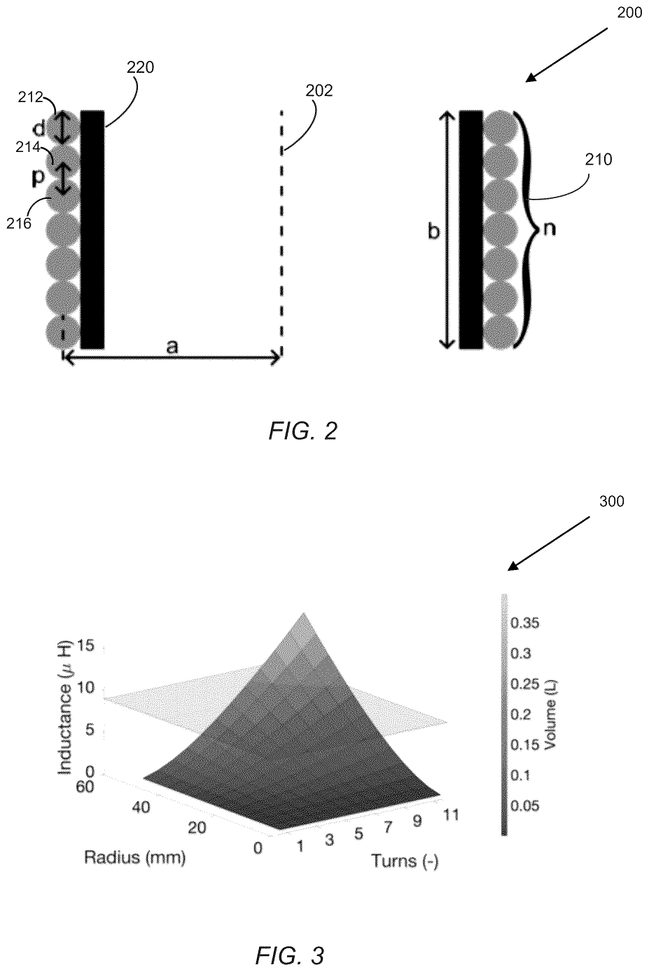

Here L is the inductance in μH, a is the radius, and b is the length/height of the inductor, both given in inches. The formula assumes a single winding layer, does not consider spacing between windings (p=d; see FIG. 2), and is accurate for b>0.8a. FIG. 2 is a cross sections diagram, cut along the longitudinal axis 202 of an air core inductor 200, and presenting various parameters of the air core inductor design. As shown in FIG. 2, the inductor 200 includes a winding 210 with n turns. In some embodiments, the winding 210 may be wrapped on a support structure 220 (e.g., a bobbin) that, together with the winding 210, define an interior core that is free of any other structure (magnetic or otherwise) passing through the inductor core. Each turn of the winding has a substantially uniform diameter d, as illustrated with respect to the winding turn 212. The distance between the centers of adjacent turn (such as turns 214 and 216) is defined asp, with p=d in some examples.

The air core is designed with the primary goal of maximizing efficiency. Without a core, the sources of loss are the windings themselves. Resistive losses can be modeled according to P_{L}=I²R(ω), where I is the current in the conductor and R(ω) is the frequency dependent resistance. Three major phenomena are known to affect R(ω) and therefore the resistive losses. The simplest is the DC component that is purely based on the geometry and type of conductor. There are two frequency-dependent effects that increase the resistance of a wire when carrying alternating currents. First, in the skin effect, alternating magnetic fields generate eddy currents that force the conducting current into an annular “skin” of depth

$$δ = \sqrt{\frac{2 p}{ϖμ}} ,$$

where μ is the permeability of the material and ρ is its resistivity. Second, the proximity effect describes the tendency of currents in adjacent wires to bundle, again because of eddy currents. Both effects are summarized in the Dowell equation, which describes the change in resistance as frequencies increase. These effects are commonly mitigated through the use of many small, individually isolated wires that are bundled to form a Litz wire. To reduce the proximity effect, the strands are twisted within the wire, exposing each wire to different electromagnetic fields. The use of this wire, while more expensive, greatly reduces the frequency dependent effects in the range of interest, thus improving efficiency.

The equations describing these mechanisms can be formally incorporated into an optimization problem to solve for the minimally resistive inductor at a given inductance. However, another, simpler, approach is to maximize the inductance of an air core inductor for a given wire length, assuming a given wire diameter. All of the loss mechanisms described above are directly dependent on the length of the conductor. By minimizing this length for a given inductance, all forms of loss are mitigated. Since the loss mechanisms are dependent on the length of the conductor, such losses are, equivalently, dependent on the number of turns, n. By minimizing n for a given inductance, losses are mitigated.

To do this, the substitutions

$$a = \frac{w}{2 π n}$$

and b=nd are placed into Eq. 3, provided above, resulting in,

$$L = \frac{{w}^{2} n}{9 ( 2 π w ) + 10 {d ( 2 π w )}^{2}} \qquad ( Eq . 4 )$$

where w is the total length of the wire.

Setting the derivative of L with respect to the number of turns equal to zero results in a point of maximum inductance and the value of n that achieves it. Using this value and some algebraic manipulations, an optimal “shape ratio,” the ratio of inductor length to diameter, of b/2a=0.45 is derived. It is notable that the optimal point found is in a broad, shallow minimum, meaning that small deviations from the reported optimal shape ratio will not result in large resistance changes. FIG. 3 is a graph 300 illustrating the behavior of the optimized Wheeler formulation (expressed in Eq. 3) for a fixed shape ratio of 0.45, showing L versus a in mm and n turns, for a desired 9 μH inductance. The target inductance of 9 μH is represented by the gray plane. To narrow the inductance selection, the shading in FIG. 3 is based on the total volume of the air core cylinder. The final air core inductor used was measured to have a value of 9.2 μH and a radius of 42 mm, a height of 40 mm, and 10 turns. A small change (2 mm) in the effective radius due to the thickness of the wire is taken into account.

In experimentation and evaluation of the implementations described herein, a standalone air core inductor was constructed with a Litz wire that was equivalent to 10 AWG and supported frequencies up to 800 kHz, well within the operating range of this converter. The air core inductor was wound around a 3D-printed bobbin (corresponding to the support structure 210 of FIG. 2). This allowed for the specified diameter to be created multiple times. Slots were added in the cylindrical bobbin as attachment points for zip ties to keep the windings in place despite repeated repositioning and vibrations. Holes in the bobbin were made to allow for mounting or positioning in a system.

Performance and behavior of the constructed standalone air core inductor was compared to the behavior and performance of a cored inductor implemented using an efficiency-volume optimization process. The result was a compact design with two paralleled E42/21/20 3F36 Ferroxcube cores, a 6.2 mm airgap, and 8 paralleled turns of Litz wire. It had an inductance of 8.3 μH. A MnZn ferrite core was chosen because of its availability and its combination of high permeability and low loss. Other modifications to this design, such as distributed air-gaps, may not increase efficiency. In addition to a copper loss mechanism, the cored inductor experienced iron losses. In particular, the structure of the ferrite means that the hysteresis losses dominate. Magnetic losses are modeled by the Steinmetz equation, a curve fitting equation that relates the power loss density to the frequency and magnetic flux density as in,

$${P}_{v} = {kf}^{a} {B}^{b} , \qquad ( Eq . 5 )$$

The equation is not fully accurate for non-sinusoidal excitations. This can be partially compensated for by using the improved generalized Steinmetz equation, but even this does not account for all situations. The currents seen by the inductors are sawtooth waveforms that vary in magnitude, frequency, and bias, making them particularly difficult to model using any form of the Steinmetz equation.

As noted, in some embodiments, the air core inductors included in the power conversion platform 100 may be standalone inductors, that are not intertwined with any other inductor. On the other hand, in some embodiments, at least some of multiple air core inductors that are used in power conversion systems (and/or other types of systems) may be combined in an interwoven configuration which allows for reduction in the volume and space that would otherwise be required to arrange the multiple air core inductors in such systems.

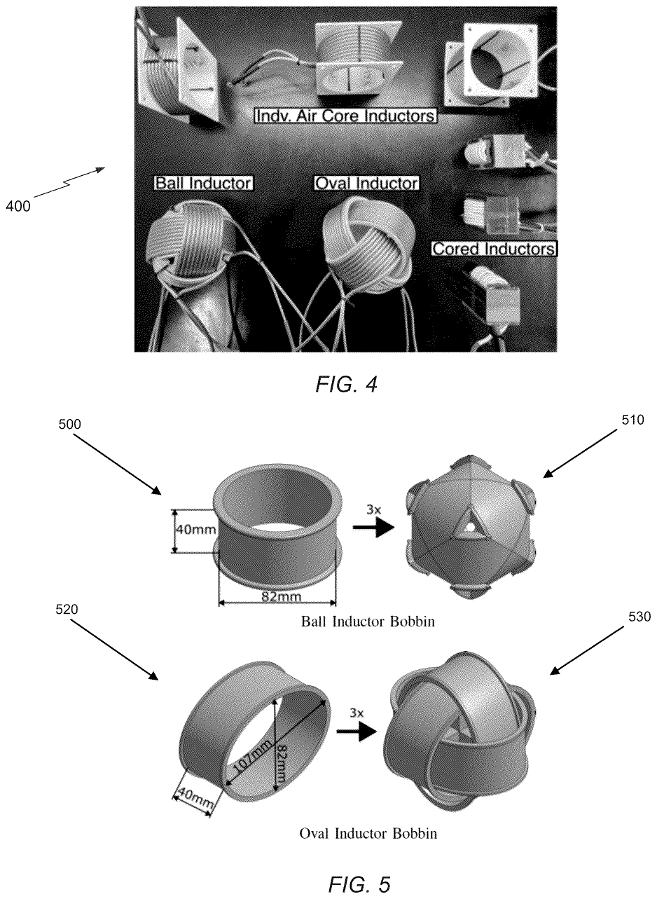

One example interwoven configuration of multiple air core inductors is the triaxial configuration. The triaxial inductor aims to increase the inductor power density by incorporating three air core inductors into a single structure. Two configurations/designs demonstrate a tradeoff between volume and the proximity effect. The first configuration focuses on volume and maintains the cylindrical shape and size of the individual air core inductors as much as possible. The second configuration aims to reduce the proximity effect losses that occur when AC excited wires induce magnetic fields in neighboring wires. This leads to an oval shape whose volume is minimized while allowing the ten turns of wire to pass around each other without touching. The different inductors that were tested and compared are shown in FIG. 4, and include individual air core inductors, a ball inductor (comprising three interwoven air core inductors), an oval inductor (also comprising three interwoven air core inductors), and cored inductors.

The over-under weaving design of both inductors ensure the three windings are evenly distributed with respect to one another. In this way, the three windings will all be of the same size and shape. This also increases winding stability at the cost of increased complexity in assembly. Furthermore, they are equally exposed to the ambient air for cooling and equally subject to the losses caused by the adjacent inductor windings.

FIG. 5 includes diagrams of bobbin structures that include a bobbin structure 500 (the starting cylinder structure) that is used to assemble an ball-shaped interwoven triaxial air core inductor 510, and an oval-shaped (elliptical) starting cylinder structure 520 that is used to assemble an oval-shaped interwoven triaxial air core inductor 530. For the ball-shaped inductor 510, the three wires of the ball inductor are wound around a ball-shaped bobbin (that may have been produced through 3D-printing). The bobbin starts with three intersecting flanged cylinders with the same dimensions as the bobbins used for the individual inductors. The “extra” parts of the cylinders are removed and the union of the remaining shape forms the bobbin. The bobbin shape serves two purposes. The first is to reduce the lateral falloff of a perfectly spherical bobbin. If a sphere were to be used, the wires on the outer edges of the windings would be of a smaller radius than the inner edges. This would lead to inconsistency in the magnetic field generation and further degradation in inductance predictability. The second purpose is to hold the wires in place using the triangular remnants of the flanges from the starting cylinder. They are also used to enforce magnetic independence by keeping the windings mutually orthogonal and to provide locations for securing zip-ties. In some embodiments, the windings take on an oblong shape as they pass over each other. Despite this, once wound around the bobbin the self-inductance measures to an average value of 9.72 μH, compared to the 9.73 μH predicted by Eq. 3.

The oval inductors (individual oval inductor 520 and the triaxial inductor 530) are structured to prevent or inhibit the windings of the three inductors from touching. The design starts with an elliptical structure 520 whose semi-minor axis is, in some embodiments, the same length as the radius of the ball inductor base design). The length of the semi-major axis is made just long enough so that the ten wires from another winding can pass underneath without touching the upper part of the bobbin, as more particularly shown in the inductor configuration 530. A supporting cross can be added to keep the three parts of the bobbin in place. This bobbin forces each inductor to have an even more pronounced eccentricity than the ball inductor. For the testing and evaluation, the Wheeler formulation was used for prediction of the inductance of each oval winding. In place of the conventional radius, the geometric mean of the semi-major and semi-minor axes was used to match the area of the ellipse to that of an equivalent circle. This gave a predicted value of 10.5 μH compared to a measured average self-inductance value of 11.2 μH. While less accurate than the ball inductor measurement, since inductance depends on both shape and area of the enclosed space, this still gives a reasonable estimate of the expected inductance.

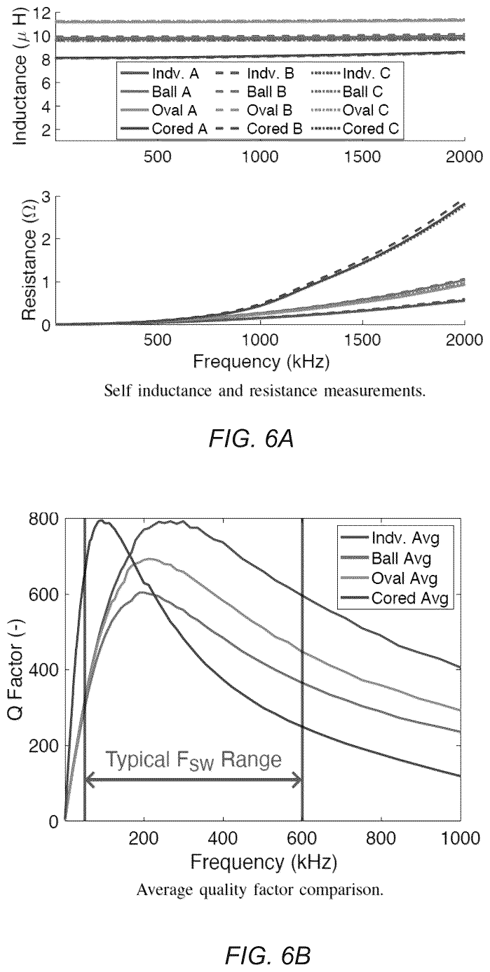

Next, characteristics of the various inductors described herein are analyzed in terms of inductance, resistance, resulting quality factor, volume, and mass. Starting first with inductance and resistance, a Keysight E4980A LCR meter was used to measure the inductance and equivalent series resistances of the windings. FIG. 6A includes plots showing the self-inductances and frequency dependent resistances of the inductors that were tested and evaluated. As expected, the inductances are independent of frequency even beyond the range of interest. The resistances, meanwhile, each follow a roughly quadratic relationship with frequency as the skin and proximity effects increase the effective resistance. It should be noted that the designs all use different lengths of wire. To account for this, Table I shows the lengths of wire used in each design, as well as the resistances and inductances per meter of wire, evaluated at 250 kHz (a rough midpoint in the switching frequency range). This helps compare inductor designs more directly.

TABLE I
Per-length measurements @ 250 kHz

| Inductor | Wire Length (m) | Inductance (μH/m) | Resistance (mΩm) |
|---|---|---|---|
| Cored | 1.78 | 4.57 | 13.1 |
| Indv. | 3.08 | 3.15 | 6.33 |
| Ball | 3.21 | 3.05 | 8.26 |
| Oval | 3.56 | 3.14 | 7.31 |

The measurements indicate that the geometry of the ball inductor is slightly worse at generating the flux linkage necessary to produce inductance. However, the oval inductor matches the effectiveness of the individual inductors. The proximity effect, meanwhile, increases the effective resistance more acutely in the ball inductor than the oval inductor. This matches expectations as the magnetic fields generated by the wires falls off with distance. Despite the cored inductor using much less wire, it has a higher effective resistance. To measure their ideality, the inductor quality factor is computed according to:

$$Q = \frac{ω L}{R ( ω )} \qquad ( Eq . 7 )$$

where ω is the angular frequency and R(ω) is the resistance at that frequency. The average value of the three windings for each type of inductor is plotted in FIG. 6B. All air core quality factors peak between 200 and 300 kHz, making these inductors ideal for use with the expected switching frequency range. The individual inductors are the closest to ideal followed by the oval and the ball inductors. This is again likely due to the proximity effect in between adjacent windings in the ball inductor.

The Q of the cored inductor, meanwhile, peaks and falls off much more quickly, highlighting the increased effects of the switching frequency on the core. Furthermore, cored inductors experience losses not modeled by the quality factor. The effective R(ω) will increase with larger excitations because of the cored losses, but this is not the case for the air core inductors.

Turning next to the coupling of the various air core configurations tested and evaluated, The orthogonality of the windings means that the flux produced by one should not pass through the others. This lack of flux linkage mitigates mutual inductance and the triaxial inductors should therefore be uncoupled. To verify this, a coupling matrix was created to demonstrate that the three windings are effectively magnetically independent. If the windings were not independent, the system model would deteriorate, potentially leading to unbalanced or non-linear behavior and loss of control. Further, the soft-switching relationship would no longer hold, resulting in increased loss. The coupling matrix is an extension of the two winding transformer coupling coefficient. It can be created for any number of coils as it is defined pairwise. For three coils, the matrix, K, is defined as:

$$K = [ \begin{matrix}1 & {k}_{12} & {k}_{13} \\ {k}_{21} & 1 & {k}_{23} \\ {k}_{31} & {k}_{32} & 1\end{matrix} ] ,$$

where

$${k}_{ij} = \frac{{M}_{ij}}{\sqrt{{L}_{i} {L}_{j}}} ,$$

with Mᵢⱼ being the mutual inductance between two coils, and Lᵢ being the self-inductance of a coil. Direct measurement of the mutual inductance is difficult and so creation of the coupling matrix proceeded through measurement of the differential and cumulative inductance values. The differential inductance is the result of a measurement in which positive current flows into one dotted terminal of the transformer in question, and out of the other. Cumulative inductance is the result of positive currents flowing into both dotted terminals.

The cumulative and differential inductances of both the ball and oval inductors were measured and the coupling matrices were constructed. With a 250 kHz excitation, the results were:

$${K}_{ball} = [ \begin{matrix}1. & 0.011 & 0.005 \\ 0.013 & 1. & 0.012 \\ 0.005 & 0.015 & 1.\end{matrix} ] ,$$

$${K}_{oval} = [ \begin{matrix}1. & - 0.004 & 0.001 \\ 0.003 & 1. & 0.005 \\ 0.001 & 0.005 & 1.\end{matrix} ] .$$

The negative coupling value is caused by slight deviations from perpendicularity in opposite directions between two windings when measuring their inductances. This means that the flux induced by the applied current is in the opposite direction thus causing a negative measured mutual inductance. Physics requires that kᵢⱼ=kⱼᵢ; unequal values are therefore attributed to measurement error. The average coupling values of the two inductors are 1% and 0.3% coupled, respectively. These values are small enough to conclude that the windings are effectively independent.

One of the main advantages of the triaxial inductor is the increase in power density compared to the individual design. Table II shows the bounding-box volume and the mass of the various configurations/designs.

TABLE II
Physical Inductor Measurements

| Inductor | Volume (cm³) | Mass (g) |
|---|---|---|
| 3x Cored | 370 | 1348 |
| 3x Indv. | 1,118 | 744 |
| 3x Indv. | 3,289 | 744 |
| Ball | 994 | 718 |
| Oval | 1,521 | 813 |

However, the individual inductors cannot simply be placed side by side as this would lead to coupling. Therefore, also included is the volume of the individual air core inductors laid out one (1) diameter apart with their axes oriented orthogonally to each other (as shown in the image 400 of FIG. 4). The volumes include bobbins and windings, but not wire leads. While the cored inductor's volume is the smallest (but also the heaviest of the various configurations), the bounding-box volume of the ball inductor is greatly reduced compared to the individual air core inductors. The ball inductor's bounding box volume is 3.3× lower than this total bounding-box volume. The oval inductor's bounding box, is 2.2× smaller than that of the separated air core inductors and the cored inductors are almost 9× smaller.

The mass of the cored inductors is almost 2× that of the individual air core inductors and the ball inductor is even lighter. It should also be noted that the approximately 50% of the mass of the cored inductor is taken up by the core itself. This is in contrast to the air core inductors in which >90% of the mass comes from the wires. The data presented herein also indicates that there is trade-off between volumetric (but not gravimetric) power density and inductor performance. The individual inductors perform best but take up the most volume. In contrast, the cored inductors are the smallest but have the highest resistance. The triaxial inductors represent a compromise between the two extremes. Another advantage of triaxial inductors is that as power levels per inductor increase, the necessary inductance to maintain soft switching decreases for the same frequency range.

To conduct some of the testing and evaluation for the implementations considered, the various inductors were simulated in Ansys Maxwell to compare their magnetic properties. The coils were excited with an approximation of the switching ripple current at 50 kHz, 150 Apk. This represents the highest peak ripple currents experienced during operation at 20 kW.

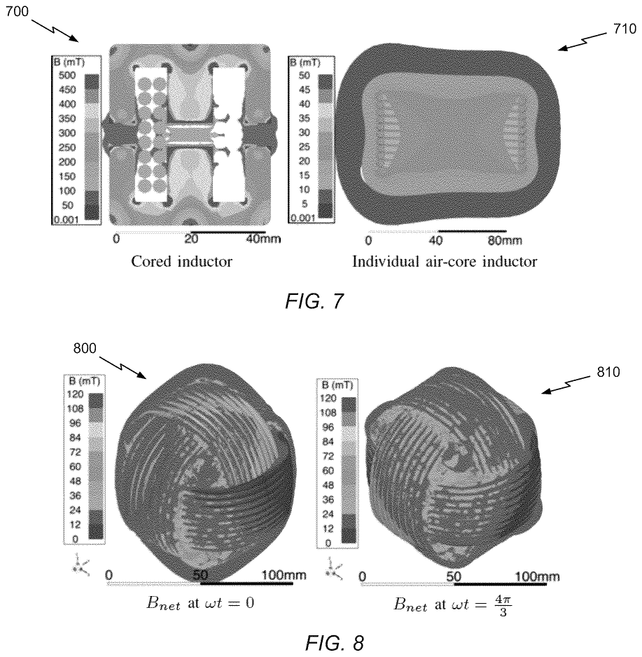

With respect to the individual air core and cored inductor simulations, FIG. 7 includes images 700 and 710 representing simulation results showing the distribution of the magnetic flux density in the simulated cored inductor and in the individual air core inductor, respectively, as a result of the applied excitation. As illustrated in the image 700, despite the large airgap, the B-field within the core is high, with parts exceeding 500 mT. The increased flux at the corners, caused by fringing fields, represent locations of high loss, which limit the operation of the core. In order to maintain practical use with a core, it is typical to increase the core volume rather than the airgap. However, increasing the volume to sufficiently reduce the magnetic flux density to prevent high loss density would bring it to a volume comparable to that of the air core inductor. At that point, the air core inductor should be considered equally with the cored inductor in terms of inductance and power density.

The removal of the core results in a lower magnetic flux density, as seen in the 10× lower scale of the image 710 of FIG. 7, as compared to the image 700. However, the magnetic field also covers a larger area as seen in the 2× larger scale.

Next, behavior of the various triaxial inductors were simulated. The net magnetic field of the triaxial inductors is more complicated. It is dependent on the three excitations of the individual windings. A simplified model is a vector in space whose component magnitudes are equal but vary sinusoidally 120° out of phase with each other. For the case of the balanced system in question, it can be represented by,

$${B}_{net} = [ \begin{matrix}b cos ( ωt ) \\ b cos ( ω t + \frac{2 π}{3} ) \\ b cos ( ω t + \frac{4 π}{3} )\end{matrix} ]$$

where b is the magnitude of the magnetic field and t is time. The phase shifts in time cause the net vector, Bₙₑₜ, to rotate in space with a fixed magnitude.

FIG. 8 includes images 800 and 810 representing simulation results showing how the magnetic field of the ball inductor varies at different sinusoidal excitations. The results are presented at the same scale and the same viewing orientation to emphasize the rotation of the net field. The images 800 and 810 show snapshots of the B-field as the phase of the excitation changes. The fields do not extend far beyond the boundaries of the inductor itself. This rotation both complicates and simplifies the physical placement and orientation of the inductor in relation to the converter and other sensitive equipment. Compared to the individual inductor's z-axis, there is no longer a single orientation that is the most likely to cause interference. Additionally, the isotropic nature of the EMI produced by the triaxial inductor provides flexibility, as long as the distance is sufficiently large to prevent unintended behavior.

Next, in order to compare inductor performance, the various inductors used in the testing and evaluations were placed into a test circuit and operated under the same voltage and current conditions. The test circuit included 3-phase PFC stages (similar to the system depicted in FIG. 1), made to interface with a European grid. Experimental parameters included bus voltage (V_{DC}) 800V, grid voltage (V_{Grid}) 400 V_{LL}, grid frequency (f_{Grid}) 50 Hz, power per converter (P)>20 kW, and switching Frequency f_{sw} 50-500 kHz.

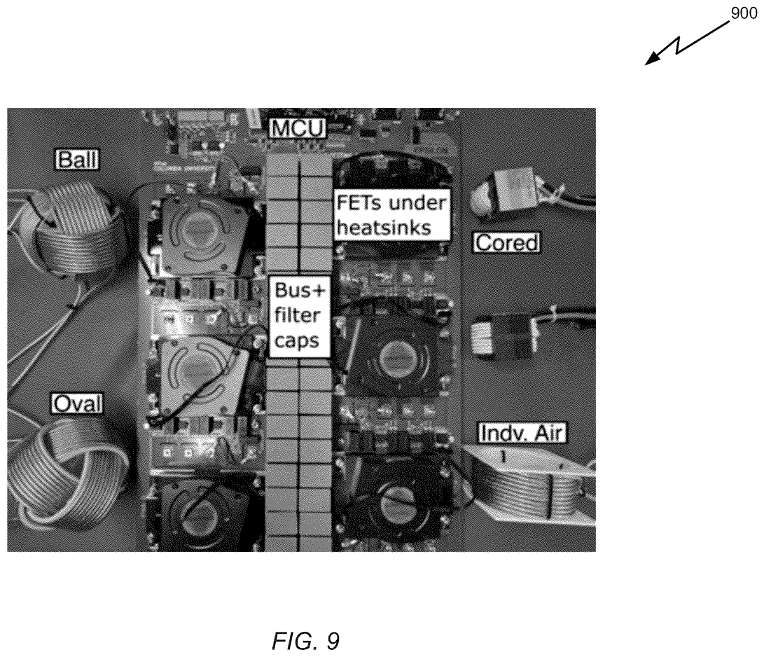

The stages can be optionally interleaved to double output power. Control was performed using a TI microcontroller (MCU) integrated into the converter and programmed in C. Experiments were performed by setting real current references for the converter to target using the inductors in question. FIG. 9 includes an image 900 of a software-defined power electronics (SDPE) testing platform used for experimental verification. The PCB has six half-bridge subcircuits with a common DC bus that can be configured as desired by attaching different magnetics and adjusting the control. The half-bridges were built from 1200V 7 mΩ SiC MOSFETS from Infineon. For compactness and comparison purposes, the image 900 also shows all of the various inductors that were used. However, when testing the interleaved circuitry, all six half bridges would be configured with the same type of inductor. External AC and DC bidirectional sources were used as the source and load.

During operation, the inductors were placed adjacent to the PCB and, despite the proximity, the EMI generated was not enough to interfere with the proper operation of the circuit. No additional measures were taken to guard the circuit against EMI. The digital gate drive signals, analog sensor signals, as well as the MCU were all robust to the generated noise.

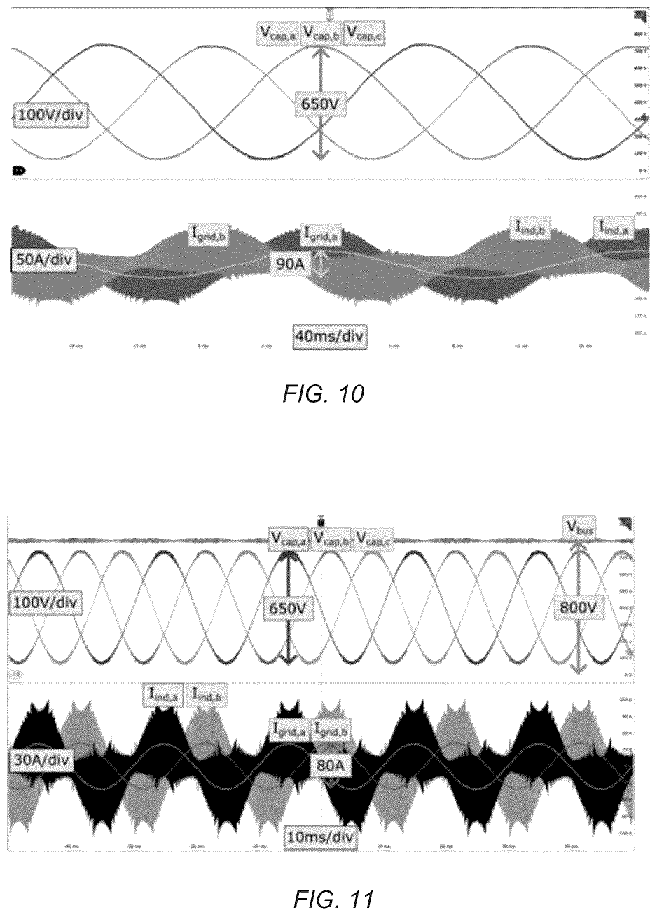

To examine the feasibility of the proposed configurations and designs, a single, non-interleaved converter was configured from the test bench. Plots with oscilloscope measurements showing the capacitor voltages, grid currents, and inductor currents for the cored inductor operating at 20 kW are provided in FIG. 10. The cored waveforms establish a baseline operation of the converter in terms of distortion and soft-switching pattern for the inductor currents. FIG. 11 includes plots with oscilloscope measurement results for the converter operating at 20 kW using the oval inductor, including the bus and capacitor voltages, as well as the ripple and inductor currents. As in the cored inductor, there was little high frequency or low frequency distortion in the currents or voltages. Additionally, the bus voltage was shown to be stable.

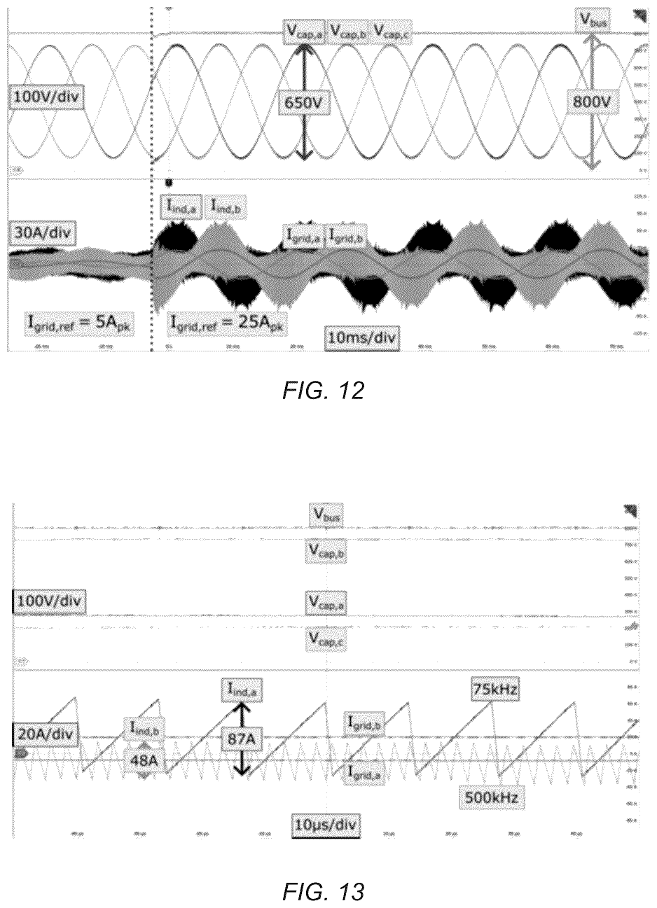

FIG. 12 includes plots showing the step response of the converter to a 20 Aₚₖ change in grid current reference, representing a change of approximately 10 kW of power. The converter reaches this set point quickly, without overshoot, and with minimal disruption to the applied voltages. This demonstrates the ability of the MCU to maintain control over the converter despite any EMI produced by the ball inductor. Similar steps were performed with the other inductors, with similar results.

FIG. 13 includes plots showing oscilloscope measurements of the ball inductor's performance at the switching period time scale. The wide current and frequency range of the VFSS process is shown up close with one phase operating at 75 kHz, 87 A, and another at 500 kHz, 48 A, so that critical ZVS (zero voltage switching) is achieved. Similar to the grid period timescale, the inductor ripple currents remain linear and in proportion with the frequency. They show no signs of distortion or coupling.

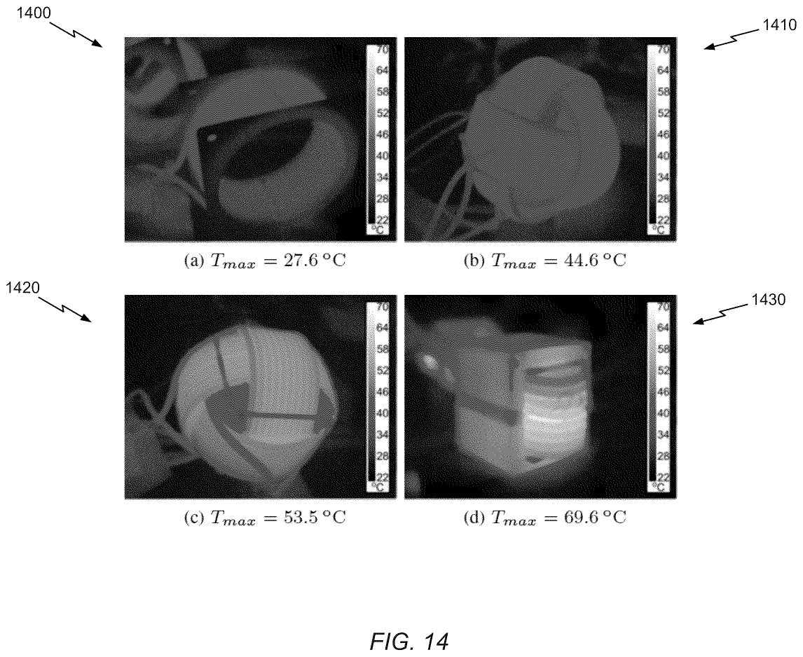

To test the thermal characteristics of the inductors, a 10 kW operating point was maintained until thermal equilibrium between the inductors and the ambient air was reached, after approximately 8 minutes. FIG. 14 includes infrared photographs of, (a) an individual air core (photograph 1400), (b) an oval inductor (photograph 1410), (c) a ball inductor (photograph 1420), and (d) a cored inductor (photograph 1430), all operating at thermal equilibrium and P_{AC}=10 kW. No forced cooling was used. The individual air core inductor was the coolest, followed by the oval, ball, and cored inductors. The maximum temperature of the ball inductor, almost double that of the individual inductor, occurred at the point of overlap between adjacent windings. The proximity effect is strongest there and air is blocked from cooling the inductor, leading to an increase in temperature. The oval inductor has a similar, lower magnitude, hot spot. The cored inductor operates even hotter than the ball inductor, with hot spots around the air-gap, likely caused by the fringing flux induced losses.

The EMI performance of the testing platform of FIG. 9 was examined next. H-field radiated emissions tests of each inductor type were conducted at 10 kW to examine the inductors' potential EMI risks. The measurements were taken using a ESA3G spectrum analyzer with a DPL200M 10 dB attenuator and a Com-Power H-field loop. The resolution bandwidth (RBW) was set to 3 kHz. Scans from 10 kHz to 1 MHz with a dwell time of 50 ms were performed. A 3 kHz RBW was chosen as a compromise across the frequencies of interest. A 50 ms dwell time was chosen to ensure that at least two full output current cycles were captured in each measurement.

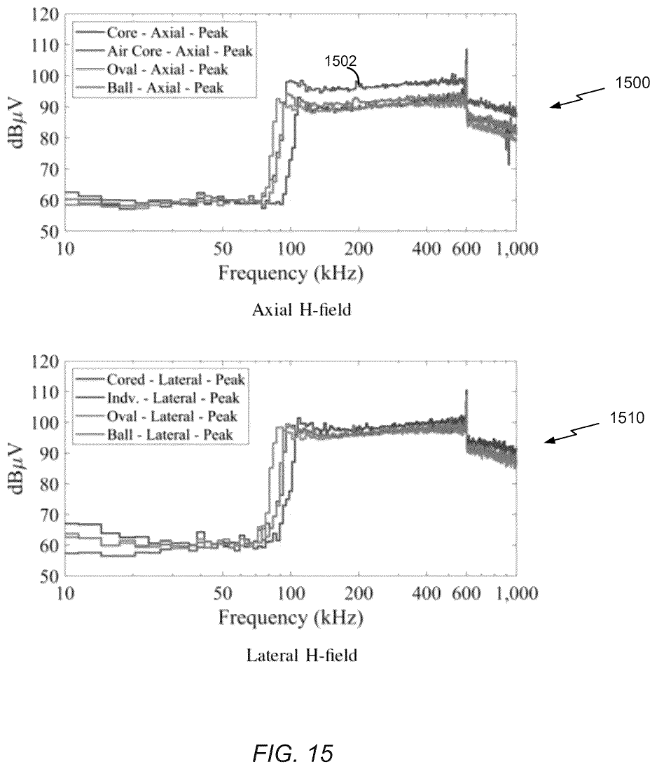

FIG. 15 includes plots 1500 and 1510 showing results of the measured peak emitted H-field. To measure the magnetic fields present around each inductor, an H-field loop probe was placed in two locations on each inductor type. The measurements specified as axial (the plot 1500) show the H-field intensity 35 mm above the top of the inductor, concentric with its central axes. The lateral measurements (the plot 1510) were taken close to the sides of the inductors to capture fringing and/or interwinding flux. In both plots, the increased intensity beginning at 75-110 kHz corresponds to the minimum f_{sw} expected at this power level for the particular inductor under test. For all configurations, the upper limit on f_{sw} was 600 kHz, which is consistent with these results.

The measured EMI is relatively flat within the switching frequency range across inductor types. For the plot 1500, one likely reason the individual air core inductor measurement (curve 1502) stands out is because the probe is able to be placed closer to the center of the inductor as compared to the triaxial inductors. Notably, the cored inductor is not much weaker at this distance. It is hypothesized that the lateral measurements are all similar because each captures more of the individual winding H-field and less of the entire coil's H-field.

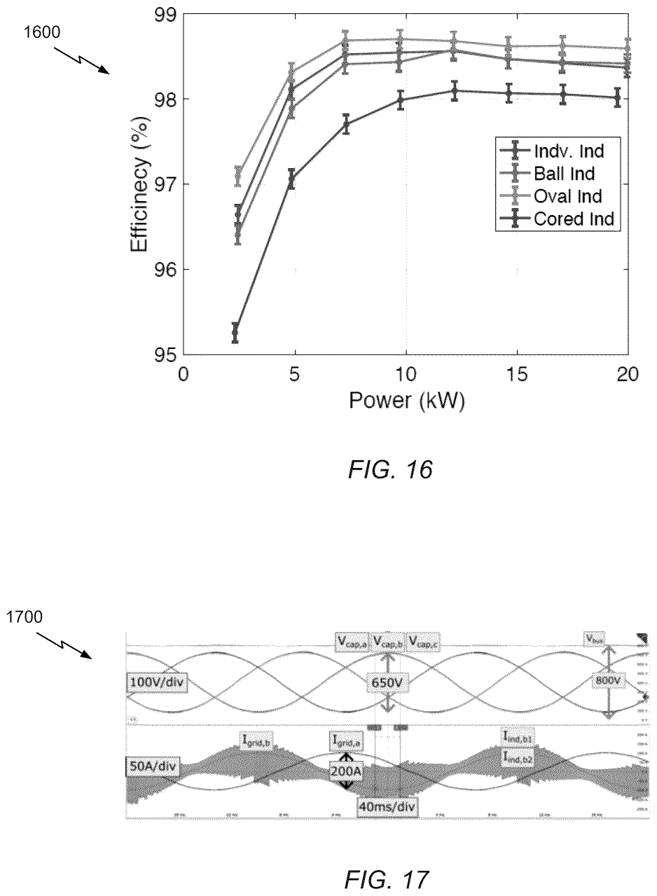

Similar power levels were attained with all inductors and the total converter efficiency was measured with only the inductor changed between tests. FIG. 16 includes a plot 1600 showing efficiency measurements of the different inductors for up to 20 kW using the non-interleaved structure. Measurements of the grid voltage and current for the AC side, and the bus current and voltage for the DC side were taken using a Dewetron DEWE3-PA8 power analyzer with an efficiency accuracy of 0.11%. The individual inductor outperformed the ball inductor at low powers, and therefore higher frequencies, but the ball inductor was able to match the efficiency above power levels of 12 kW. This is likely because at higher powers, the lower frequencies present have reduced proximity effect losses. The oval inductor had the highest measured efficiency at 98.7%. This is due to the larger inductance allowing for more ripple at a given frequency, reducing loss. The trade-off here is that the inductor cannot support higher powers while maintaining ZVS.

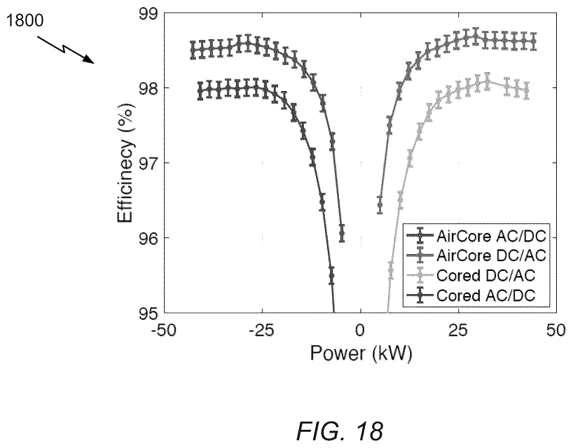

Finally, the cored inductors performed significantly worse. The converters were also interleaved to demonstrate higher power capabilities, greater than 44 kW. FIG. 17 includes a plot 1700 of waveform results using the air core inductor, showing the current ripple and resulting grid current, while operating at 44 kW. In particular, the inductor currents are overlaid but 180° out of phase to partially cancel the ripple, reducing current stress in the filter capacitors. FIG. 18 includes a plot 1800 of an efficiency comparison between air core and cored inductor setups as measured with a power analyzer. The results provided by the plot 1800 show the efficiencies as power flows increase bidirectionally. The air core significantly outperforms the cored inductor across the entire range. The percent increase in savings is largest at lower powers but is still >0.5% at high powers. This again could be because of increased savings at higher frequencies, typical at lower powers.

Thus, described herein are air core inductor configurations, and systems and methods incorporating such air core inductor configurations, including power electronics designs for variable-frequency, high ripple converters at power levels required by EV chargers. A design principle based on the ratio of height to radius can be used to create efficient air core inductors at a desired inductance. To reduce the volume of the air core inductors, triaxial inductors can be used to replace individual air core inductors. Implementation of triaxial inductors may be based on the Wheeler formulation. Corrections to the Wheeler formulation could be made that more directly incorporate the shape of the triaxial windings.

The inductors were characterized as appropriate for use in the switching frequency and power levels of interest and shown to be magnetically decoupled. The individual and ball inductors were found to be at opposite ends of a spectrum of power density and performance with the oval inductor sitting between them. All inductors were shown to be highly efficient as compared to a cored inductor and can operate 15-40° C. lower with only ambient cooling, no forced air. The air core inductors have been shown to increase converter efficiency by >0.5% at rated power and even more at lower powers. Compared with the cored design, the volume and extent of the magnetic field are doubled while the mass of the individual air core is decreased by 30%. The significant volume increase was partially overcome through the triaxial design, which reduced the bounding box volume by >3× compared to the individual design. The air core inductors can be configured for higher power per inductor than that tested herein.

As noted, an advantage of the triaxial configuration in VFSS converters is that as power levels increase, the inductance necessary to maintain soft switching decreases. Since the air core inductors presented are not at their thermal limits, the power density can be increased. Additionally, an increase in operating frequency may drive down inductor size without fear of a core overheating or saturating. Other triaxial inductor configurations (in addition to the ball and oval configurations described herein) may also be used.

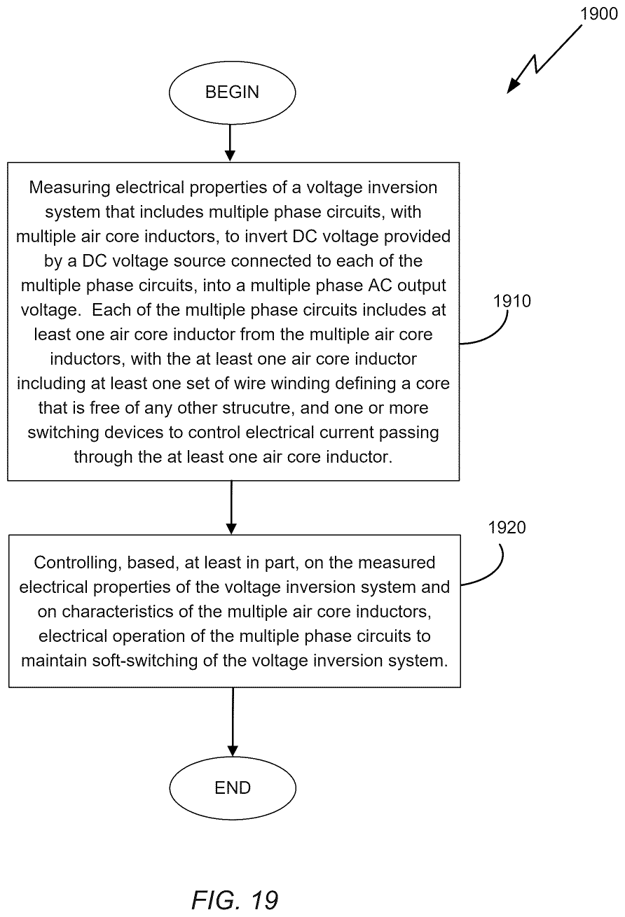

With reference next to FIG. 19, a flowchart of an example voltage inversion procedure 1900 is shown. The procedure 1900 includes measuring 1910 electrical properties of a voltage inversion system that includes multiple phase circuits, with multiple air core inductors, to invert DC voltage provided by a DC voltage source connected to each of the multiple phase circuits, into a multiple phase AC output voltage. Each of the multiple phase circuits includes at least one air core inductor from the multiple air core inductors, with the at least one air core inductor including at least one set of wire winding defining a core that is free of any other structure (such as a magnetic element), and one or more switching devices (e.g., MOSFET switching devices) to control electrical current passing through the at least one air core inductor. The procedure 1900 further includes controlling 1920, based, at least in part, on the measured electrical properties of the voltage inversion system and on characteristics of the multiple air core inductors, electrical operation of the multiple phase circuits to maintain soft-switching of the voltage inversion system. It is noted that the air core inductors may be used in conjunction with other types of power conversion procedures and systems.

In various examples, controlling the electrical operation of the multiple phase circuits may include controllably actuating the one or more switching devices respectively included in the each of the multiple phase circuits to maintain soft-switching operation of the voltage inversion system.

In various embodiments, the multiple air core inductors, respectively included in the multiple phase circuits, may be arranged into a single interwoven inductor structure. The multiple air core inductors comprising the single interwoven inductor structure can be orthogonal to each other. In some embodiments, the single interwoven inductor structure can include one or more of, for example, an interwoven ovel triaxial inductor structure with separate windings of each of the multiple inductors arranged on oval interwoven bobbins, or a ball-shaped triaxial inductor structure with the separate windings of each of the multiple inductors arranged on circular bobbins or a ball-shaped bobbin (other interwoven configurations, mounted on other types and configurations of underlying structures, may also be used).

Performing the various techniques and operations described herein may be facilitated by a controller device (e.g., a processor-based computing device). Such a controller device may include a processor-based device such as a computing device, and so forth, that typically includes a central processor unit or a processing core. The device may also include one or more dedicated learning machines (e.g., neural networks) that may be part of the CPU or processing core. In addition to the CPU, the system includes main memory, cache memory and bus interface circuits. The controller device may include a mass storage element, such as a hard drive (solid state hard drive, or other types of hard drive), or flash drive associated with the computer system. The controller device may further include a keyboard, or keypad, or some other user input interface, and a monitor, e.g., an LCD (liquid crystal display) monitor, that may be placed where a user can access them.

The controller device is configured to facilitate, for example, the implementation of a multi-phase (e.g., three phases) soft-switching inversion system implemented with air core inductors (included non-interwoven inductors, and interwoven triaxial inductor structures). The storage device may thus include a computer program product that when executed on the controller device (which, as noted, may be a processor-based device) causes the processor-based device to perform operations to facilitate the implementation of procedures and operations described herein. The controller device may further include peripheral devices to enable input/output functionality. Such peripheral devices may include, for example, flash drive (e.g., a removable flash drive), or a network connection (e.g., implemented using a USB port and/or a wireless transceiver), for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), an ASIC (application-specific integrated circuit), a DSP processor, a graphics processing unit (GPU), application processing unit (APU), etc., may be used in the implementations of the controller device. Other modules that may be included with the controller device may include a user interface to provide or receive input and output data. The controller device may include an operating system.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus, and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

In some embodiments, any suitable computer readable media can be used for storing instructions for performing the processes/operations/procedures described herein. For example, in some embodiments computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only Memory (EEPROM), etc.), any suitable media that is not fleeting or not devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

The presently disclosed subject matter is further described in the materials of Attachments A-B appended hereto. Although particular embodiments have been disclosed herein in detail, this has been done by way of example for purposes of illustration only, and is not intended to be limiting with respect to the scope of the appended claims, which follow. Features of the disclosed embodiments can be combined, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

What is claimed is:

1. A voltage inverter system comprising:
multiple phase circuits with multiple air core inductors, to invert DC voltage provided by a DC voltage source connected to the multiple phase circuits, into a multiple phase AC output voltage, wherein each of the multiple phase circuits comprises:
at least one air core inductor from the multiple air core inductors, the at least one air core inductor including at least one set of wire winding defining a core, the core being free of any other structure, and
one or more switching devices to control electrical current passing through the at least one air core inductor; and
one or more controllers to controllably actuate the one or more switching devices of the each of the multiple phase circuits to maintain soft-switching behavior of the voltage inverter system based, in part, on characteristics of the multiple air core inductors.

2. The voltage inverter system of claim 1, wherein the multiple air core inductors, included in the multiple phase circuits, are arranged into a single interwoven inductor structure.

3. The voltage inverter system of claim 2, wherein the single interwoven inductor structure defines an inductor structure volume that is smaller than the sum of volumes occupied individually by the multiple air core inductors when separated from each other.

4. The voltage inverter system of claim 2, wherein the multiple air core inductors comprising the single interwoven inductor structure are orthogonal to each other.

5. The voltage inverter system of claim 2, wherein the single interwoven inductor structure comprises one of: an interwoven ovel triaxial inductor structure with separate windings of each of the multiple inductors arranged on oval interwoven bobbins, or a ball-shaped triaxial inductor structure with the separate windings of each of the multiple inductors arranged on circular bobbins or a ball-shaped bobbin.

6. The voltage inverter system of claim 1, wherein the multiple phase circuits include three phase circuits.

7. The voltage inverter system of claim 1, wherein the one or more controllers are configured to determine variable switching frequencies for each of the one or more switching devices of the multiple phase circuits.

8. The voltage inverter system of claim 1, wherein each of the multiple phase circuits further comprises:
a capacitor electrically coupled at a first of its terminals to a first terminal of a respective air core inductor, and electrically coupled at a second of its terminals to a negative terminal of the DC voltage source;
wherein a second terminal of the respective air core inductor is electrically coupled to common terminals of the one or more respective switching devices.

9. The voltage inverter system of claim 1, wherein the multiple phase circuits, with the multiple air core inductors, are configured to operate at high current levels and/or at high current frequencies.

10. A voltage inversion method comprising:
measuring electrical properties of a voltage inversion system that includes multiple phase circuits, with multiple air core inductors, to invert DC voltage provided by a DC voltage source connected to each of the multiple phase circuits, into a multiple phase AC output voltage, wherein each of the multiple phase circuits comprises:
at least one air core inductor from the multiple air core inductors, the at least one air core inductor including at least one set of wire winding defining a core, the core being free of any other structure, and
one or more switching devices to control electrical current passing through the at least one air core inductor; and
controlling, based, at least in part, on the measured electrical properties of the voltage inversion system and on characteristics of the multiple air core inductors, electrical operation of the multiple phase circuits to maintain soft-switching of the voltage inversion system.

11. The method of claim 10, wherein controlling the electrical operation of the multiple phase circuits comprises:
controllably actuating the one or more switching devices respectively included in the each of the multiple phase circuits to maintain soft-switching operation of the voltage inversion system.

12. The method of claim 10, wherein the multiple air core inductors, respectively included in the multiple phase circuits, are arranged into a single interwoven inductor structure.

13. The method of claim 12, wherein the multiple air core inductors comprising the single interwoven inductor structure are orthogonal to each other.

14. The voltage inverter system of claim 12, wherein the single interwoven inductor structure comprises one of: an interwoven ovel triaxial inductor structure with separate windings of each of the multiple inductors arranged on oval interwoven bobbins, or a ball-shaped triaxial inductor structure with the separate windings of each of the multiple inductors arranged on circular bobbins or a ball-shaped bobbin.

15. An energy storage element for power conversion systems, the energy storage element comprising:
an inductor structure comprising multiple interwoven air core inductors, each air core inductor including at least one set of wire winding defining an interior core that is free of any other structure; and
multiple coupling terminal sets electrically coupled to the at least one set of wire winding of respective ones of the multiple interwoven air core inductors of the inductor structure, the multiple coupling terminal sets configured to electrically couple the inductor structure to circuitry of a power conversion system.

16. The energy storage element of claim 15, wherein the multiple interwoven air core inductors comprising the inductor structure are orthogonal to each other.

17. The energy storage element of claim 15, wherein the multiple interwoven air core inductors comprising the inductor structure form one of: an interwoven ovel triaxial inductor structure with separate windings of each of the multiple inductors arranged on oval interwoven bobbins, or a ball-shaped triaxial inductor structure with the separate windings of each of the multiple inductors arranged on circular bobbins or a ball-shaped bobbin.

18. The energy storage element of claim 15, wherein the inductor structure comprises three interwoven air core inductors, wherein the inductor structure is electrically couplable to circuitry of a 3-phase power conversion system.

19. The energy storage element of claim 18, wherein the inductor structure comprising the three interwoven air core inductors is configured to output at least 2.5 kW of power.

20. The energy storage element of claim 15, wherein the multiple coupling terminal sets configured to electrically couple the inductor structure to the circuitry of the power conversion system comprise multiple coupling terminal pairings that each electrically couple to a respective one of multiple phase circuits of the power conversion system.
